(19) United States
(12) Patent Application Publication
(10) Pub. No.: US 2015/0332284 A1
(43) Pub. Date: Nov. 19, 2015

(54) SYSTEM AND METHOD FOR DETERMINING SERVICE INTERVALS BASED ON TRANSACTION DATA

(71) Applicant: MASTERCARD INTERNATIONAL INCORPORATED, Purchase, NY (US)

(72) Inventors: Kenny Unser, Fairfield, CT (US); Serge Bernard, Danbury, CT (US); Nikhil A. Malgatti, Stamford, CT (US)

(73) Assignee: MASTERCARD INTERNATIONAL INCORPORATED, Purchase, NY (US)

(21) Appl. No.: 14/276,594

(22) Filed: May 13, 2014

(51) Int. Cl. G06Q 30/02

(52) U.S. Cl. CPC G06Q 30/0201; G06Q 30/0269

(57) ABSTRACT

A system for determining service intervals of a serviceable property based on payment card transaction data. A data storage device contains payment card transaction data of a plurality customers and merchants. A processor is configured to identify purchasers of a serviceable property based on processing payment card transaction data including statistical analysis of the payment card transaction data to identify relationships between different payment card transactions representing a correlation of a given property of a purchaser with a particular service linked to the property. Characteristic traits and service frequencies are determined for purchasers of the serviceable property. A particular serviceable property is selected from the payment card transaction data, and the determined profile data is applied, along with selected data characteristics of a given service, to obtain data representative of an updated service interval for a given service associated with the serviceable property.

### CROSS-REFERENCE TO RELATED APPLICATIONS

None.

### FIELD OF INVENTION

Embodiments relate to systems and methods to facilitate the determination and timing of service visits and generating communications related to services associated with a particular purchase, based on additional transactions data other than said particular purchase.

### BACKGROUND

Merchants solicit business through various means in order to attempt to influence customers' buying decisions. Such means include but are not limited to direct targeting of consumers, indirect advertisements and discount offers, promotional strategies such as direct mail, telemarketing, direct response television advertising and online selling. Merchants may also solicit leads to new business through word of mouth and relationship building, by way of non-limiting example. However, it is often challenging for merchants such as service providers to determine preferred times for soliciting certain service activities associated with a particular product. For example, it may be difficult to determine when a given product purchased by a customer requires servicing and when best to approach the user prior to the user attending to such service. Furthermore, merchant information concerning actions or events that may impact customer decisions regarding particular services, products, or service intervals is often limited. Alternative systems and methods are desired.

### SUMMARY

In embodiments, systems and computer-implemented methods provide merchants and/or businesses and third parties with enhanced data indicative of optimized conditions for approaching clients or potential clients relating to product services based on service interval determinations using payment card transaction data. Embodiments of the disclosure also relate to systems and methods to facilitate the determination and timing of service visits and generating communications related to services associated with a particular purchase, based on additional transactions data other than those associated with the particular purchase.

A system for determining service intervals of a serviceable property based on payment card transaction data, the system comprising: one or more data storage devices containing payment card transaction data of a plurality customers and merchants; one or more processors; a memory in communication with the one or more processors and storing program instructions, to cause the one or more processors to: identify purchasers of serviceable property based on processing payment card transaction data of a plurality customers and merchants in the one or more storage devices, the processing including statistical analysis of the payment card transaction data to identify relationships between different payment card transactions representing a correlation of a given property of a purchaser with a particular service linked to the property; determine, based on the payment card transaction data of the plurality of customers and merchants characteristic traits of purchasers of the serviceable property for purchasing services linked to the serviceable property, and relating to the frequency of service intervals for a given service linked with the serviceable property, to thereby provide profile data; determine a particular serviceable property identifiable from the payment card transaction data, and apply to it the determined profile data, along with one or more selected data characteristics associated with a given service linked to the serviceable property, to thereby obtain data representative of an updated service interval for a given service associated with the serviceable property. The statistical analysis of the payment card transaction data comprises one or more of i) a trend analysis, (ii) a time series analysis, (iii) a regression analysis, (iv) a frequency distribution analysis, (v) and predictive modeling.

A computer-implemented method for determining service intervals of a serviceable property based on payment card transaction data, the method comprising: identifying, by a processor, purchasers of a serviceable property based on processing payment card transaction data of a plurality customers and merchants in the one or more storage devices, the processing including statistical analysis of the payment card transaction data to identify relationships between different payment card transactions representing a correlation of a given property of a purchaser with a particular service linked to the property; determining, by a processor, based on the payment card transaction data of the plurality of customers and merchants characteristic traits of purchasers of the serviceable property for purchasing services linked to the serviceable property, and relating to the frequency of service intervals for a given service linked with the serviceable property, to thereby provide profile data; determining a particular serviceable property identifiable from the payment card transaction data, and applying to it the determined profile data, along with one or more selected data characteristics associated with a given service linked to the serviceable property, to thereby output data representative of an updated service interval for a given service associated with the serviceable property.

A computer-implemented method for determining information relating to a characteristic of a serviceable property based on payment card transaction data, the method comprising: processing payment card transaction records via an analytics engine utilizing statistical analyses and techniques to determine one or more relationships, patterns, and trends among transaction records to determine factors for predicting future transactions and estimated times and frequencies associated with such future transactions based on customer and merchant transaction profiles associated with a given serviceable property; and applying those determined factors to particular sets of payment card transaction data associated with a particular subset of customers and processing said particular sets of payment card transaction data using the analytics engine to predict in real time when the particular subset of customers of a serviceable property requires service.

### BRIEF DESCRIPTION OF THE DRAWINGS

FIG. 1 illustrates a system architecture within which some embodiments may be implemented.

FIG. 2 is a functional block diagram of a managing computer system for a payment card service provider in accordance with an exemplary embodiment.

FIG. 3a illustrates a system for providing services related to a property based on transactions data in accordance with an exemplary embodiment.

FIG. 3b illustrates exemplary transaction record data useful in implementing aspects of the present system and method.

FIG. 4 illustrates an exemplary process flow for determining information based on transaction records and applying said determined information to a select profile for providing adjustments to one or more actions or services associated with a serviceable property.

FIG. 5 illustrates another exemplary process flow for determining information based on transaction records and applying said determined information to a select profile for providing adjustments to one or more actions or services associated with a serviceable property.

FIG. 6 illustrates an exemplary process flow for performing transaction analysis of a select payment card transaction,

FIG. 7 illustrates an exemplary process flow for updating service interval predictions based on determined changes in customer purchasing frequencies based on transactions records data.

FIG. 8 illustrates another exemplary process flow for determining information based on transaction records and user requested information.

### DETAILED DESCRIPTION

Disclosed herein are processor-executable methods, computing systems, and related processing for the administration, management and communication of data relating to the servicing of serviceable properties derived from payment card transaction data from customers and merchants. Transactions data comprising a multiplicity of payment card transactions records that includes customer information, merchant information, and transaction amounts are processed to identify purchasers of serviceable properties. Transactions data may be stored in a data base (e.g. a relational data base) and analyzed to link relevant fields within various records to one another in order to determine and establish relationships (e.g. cause and effect, associations and groupings) and links between and among categories of services, customers, merchants, geographic regions, frequencies of services, and the like.

An analytics engine utilizing statistical analyses and techniques applied to the payment card transaction data is implemented to analyze the payment card transactions records to determine relationships, patterns, and trends between and among the various transaction records in order to predict future transactions and estimated times and frequencies associated with such transactions. Such statistical analyses may be targeted to particular subsets of the transactions data, including by way of non-limiting example, one or more particular geographic regions, business categories, customer categories, product or service types, and purchasing frequencies. The transaction records may be processed and segmented into various categories in order to determine purchasers of a given serviceable property, purchasing frequencies, and drivers or factors affecting the serviceable property or frequency of service, by way of non-limiting example.

It is to be understood that implementation of the present disclosure is performed without obtaining personally identifiable (private) data such that the results are not personalized. This enables maintaining privacy of a given user's identity unless the user opts-in to making such data available. In some implementations, the user data is anonymized to obscure the user's identify. For example, received information (e.g. user interactions, location, device or user identifiers) can be aggregated or removed/obscured (e.g., replaced with random identifier) so that individually identifying information is anonymized while still maintaining the attributes or characteristics associated with particular information and enabling analysis of said information. Additionally, users can opt-in or opt-out of making data for images associated with the user available to the system.

The analytics engine may utilize independent variables as well as dependent variables representative of one or more purchasing events, customer types or profiles, merchant types or profiles, purchase amounts, and purchasing frequencies, by way of example only. The analytics engine may use models such as regression analysis, correlation, analysis of variances, time series analysis, determination of frequency distributions, segmentation and clustering applied to the transactions data in order to determine and predict the effect particular categories of data have on other categories, and thereby determine drivers of particular actions or services associated with a serviceable property represented in the transactions data.

The analytics engine is further configured to determine or ascribe attributes or traits to purchasers of the serviceable property based on the analysis of the payment card transactions records. Characteristic traits or profiles of the purchasers or customers that relate to specific actions are linked to the serviceable property, and the frequency relationship or service interval for a given action associated with the serviceable property is analyzed in order to determine factors and conditions satisfying a given threshold level or score so as to be deemed to influence or predict the frequency relationship of the particular service associated with the serviceable property.

In accordance with an aspect of the present disclosure, after determining using the analytics engine those factors that may affect (to different degrees) changes in service intervals of a particular business service or product, those factors may be applied back into particular sets of the payment card transaction data associated with particular customers and processed in order to determine or forecast in real time when a particular customer or set of customers of a serviceable product might require service.

In one embodiment, upon determination of factors deemed to influence service or selection frequency associated with a particular serviceable property identifiable from the payment card transaction data, a transaction selection process applies those factors to select transaction record data. Customer profile data, along with one or more user selected data characteristics associated with a given action of the serviceable property, enables one to obtain data representative of a service interval of the serviceable property adjusted by the user selected data characteristics. In this manner, application of the logic developed using the above process enables customers, markets, and/or service providers to deliver information and meaningful insight relating to various commercial and consumer related applications.

In accordance with an exemplary embodiment, the system and method described herein provide a framework to utilize payment card transactions to provide data representative of actions to be taken with respect to one or more serviceable properties identifiable from the payment card transaction data.

It is to be understood that a payment card is a card that can be presented by the cardholder (i.e., customer) to make a payment. By way of example, and without limiting the generality of the foregoing, a payment card can be a credit card, debit card, charge card, stored-value card, or prepaid card or nearly any other type of financial transaction card. it is noted that as used herein, the term “customer”, “cardholder,” “card user,” and/or “card recipient” can be used interchangeably and can include any user who holds a payment card for making purchases of goods and/or services. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction acquirer” can include, for example, a merchant, a merchant terminal, an automated teller machine (ATM), or any other suitable institution or device configured to initiate a financial transaction per the request of the customer or cardholder,

A “payment card processing system” or “credit card processing network”, such as the MasterCard network exists, allowing consumers to use payment cards issued by a variety of issuers to shop at a variety of merchants. With this type of payment card, a card issuer or attribute provider, such as a bank, extends credit to a customer to purchase products or services. When a customer makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The card issuer or attribute provider may also charge an annual fee.

A “business classification” is a group of merchants and/or businesses, classified by the type of goods and/or service the merchant and/or business provides. For example, the group of merchants and/or businesses can include merchants and/or businesses which provide similar goods and/or services. In addition, the merchants and/or businesses can be classified based on geographical location, sales, and any other type of classification, which can be used to define a merchant and/or business with similar goods, services, locations, economic and/or business sector, industry and/or industry group.

Determination of a merchant classification or category may be implemented using one or more indicia or merchant classification codes to identify or classify a business by the type of goods or services it provides. For example, ISO Standard Industrial Classification (“SIC”) codes may be represented as four digit numerical codes assigned by the U.S. government to business establishments to identify the primary business of the establishment. Similarly a “Merchant Category Code” or “MCC” is also a four-digit number assigned to a business by an entity that issues payment cards or by payment card transaction processors at the time the merchant is set up to accept a particular payment card. Such classification codes may be included in the payment card transactions records. The merchant category code or MCC may be used to classify the business by the type of goods or services it provides. For example, in the United States, the merchant category code can be used to determine if a payment needs to be reported to the IRS for tax purposes. In addition, merchant classification codes are used by card issuers to categorize, track or restrict certain types of purchases. Other codes may also be used including other publicly known codes or proprietary codes developed by a card issuer, such as NAICS or other industry codes, by way of non-limiting example.

As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

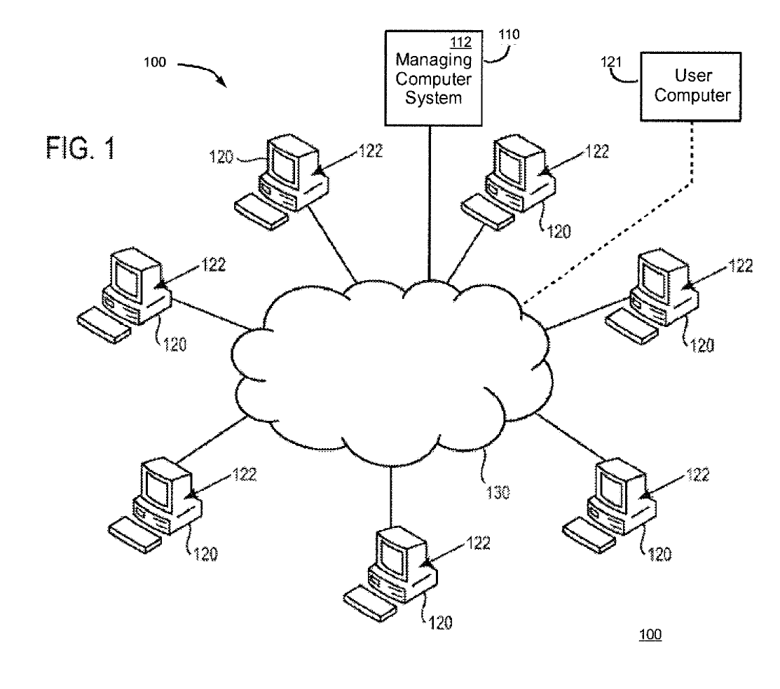

Referring now to FIG. 1, there is shown an exemplary system for providing services based on payment card transactions data according to an embodiment of the disclosure. The system of FIG. 1 illustrates a high-level diagram of a system architecture that may be employed in accordance with an exemplary embodiment. As shown in FIG. 1, the system 100 includes a managing computer system 110 that includes a data store or data warehouse for storing payment card transaction records associated with a payment card service provider 112. Each payment transaction performed by a transaction acquirer and/or merchant 122 having a corresponding merchant computer system 120 is transferred to the managing computer system 110 via a network 130 which connects the computer system 120 of the transaction acquirer or merchant 122 with the managing computer system 110 of the payment card service provider 112.

The network 130 can be virtually any form or mixture of networks consistent with embodiments as described herein include, but are not limited to, telecommunication or telephone lines, the Internet, an intranet, a local area network (LAN), a wide area network (WAN), virtual private network (VPN) and/or a wireless connection using radio frequency (RF) and/or infrared (IR) transmission to name a few.

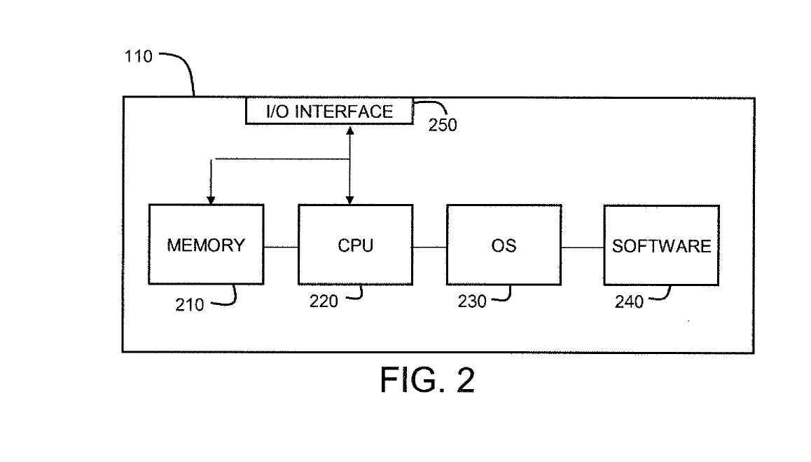

The managing computer system 110 for the payment card service provider 112 as shown in FIG. 2 includes at least one memory device 210 configured to store data that associates identifying information of individual customers, merchants, and transactions associated with payment card accounts. System 110 further includes a computer processor 220, and an operating system (OS) 230, which manages the computer hardware and provides common services for efficient execution of various logic circuitry including hardware, software and/or programs 240. The processor 220 (or CPU) carries out the instructions of a computer program, which operates and/or controls at least a portion of the functionality of the managing computer system 110. System 110 further includes device input/output interface 250 configured to receive and output network and transactions data and information to and/or from managing computer system 110 from and/or to peripheral devices and networks operatively coupled to the system. Such devices may include user 121 and/or merchant 120 terminals, including point of sale (POS) terminals, wireless networks and devices, mobile devices and client/server devices, and user interfaces communicatively coupled over one or more networks for interfacing with managing system 110. The I/O interface 250 may include a query interface configured to accept and parse user requests for information based on or utilizing the payment card transactions data. In addition, the I/O interface may handle receipt of transactions data and perform transactions based processing in response to receipt of transactions data as a result of a particular purchase via a POS terminal, by way of non-limiting example only.

The at least one memory device 210 may be any form of data storage device including but not limited to electronic, magnetic, optical recording mechanisms, combinations thereof or any other form of memory device capable of storing data, which associates payment card transactions of a plurality of transaction acquirers and/or merchants. The computer processor or CPU 220 may be in the form of a stand-alone computer, a distributed computing system, a centralized computing system, a network server with communication modules and other processors, or nearly any other automated information processing system configured to receive data in the form of payment card transactions from transaction acquirers or merchants 122. The managing computer system 110 may be embodied as a data warehouse or repository for the bulk payment card transaction data of multiple customers and merchants. In addition, the computer system 120 or another computer system 121 (e.g. user computer of FIG. 1) connected to computer system 110 (via a network such as network 130) may be configured to request or query the managing computer system 110 in order to obtain and/or retrieve information relating to categories of customers, merchants, and services associated therewith, based on information provided via the computer system 120 or 121 and profiling of the transaction data contained in computer system 110 according to the particular query/request.

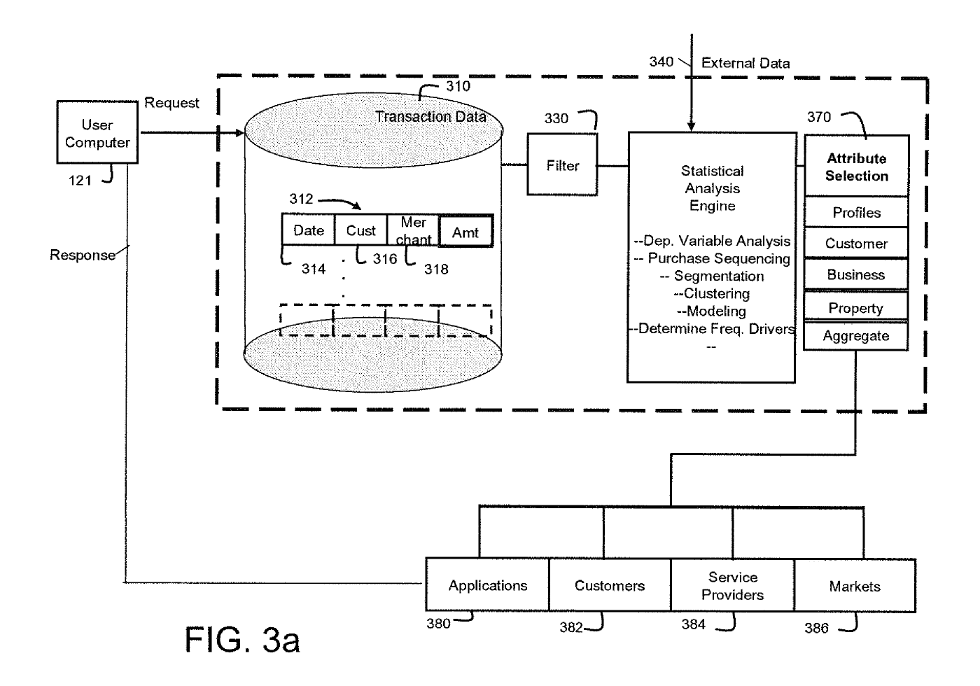

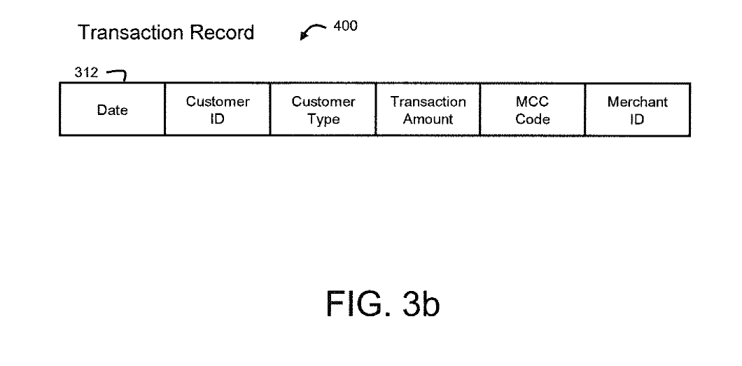

Referring now to FIG. 3, there is shown a system block diagram and operational flow for determining service intervals of a serviceable property based on payment card transactions data according to an exemplary embodiment of the present disclosure. It is understood that the payment card transactions data represent voluminous transactions records that are associated with a multiplicity of customers and merchants in a wide variety of businesses and geographic regions over a relatively long period of time (e.g. 3-10 years or more). It is further understood that certain merchants or businesses may be categorized as recurrent services such as auto mechanics or car repair shops, appliance stores, and fuel service delivery shops, by way of non-limiting example only. Such types of recurrent services or merchants may be particularly well suited to benefit from embodiments of the present disclosure by receiving information output from system 110 directed to providing enhanced data relating to updated predicted customer delivery schedules, updated customer product repair intervals, and updated customer lists of potential or existing customers predicted to require servicing of a given product within a predetermined future time interval.

Referring to FIG. 3, a database 310 containing a multiplicity of transaction data is included in managing computer system 110 (FIGS. 1 and 2). The transaction data is configured and processed via an analytics engine 350 to provide intelligent information and profiling of transaction data for categorizing customers, merchants, products, services and purchasing frequencies, by way of non-limiting example. The transaction database 310 includes payment card transaction records 312 which may be augmented with non-payment card transaction data labeled as external data 340. The external data may reside within the same transactions data base or may be linked in a separate date base, by way of non-limiting example. The payment card transactions records 312 may be obtained via various transaction mechanisms, such as credit and debit card transactions between customers and merchants. The external data 340 that may optionally be included in the transactions data may include samples of itemized or detailed receipts, firmographics, market data, example service intervals associated with particular products, merchants, and/or geographic regions, and example warrantee periods associated with particular products, merchants, and/or geographic regions, by way of non-limiting example. Such data may operate to link customers and merchants with particular purchases of products or services within a given transaction. Additional information such as transaction data relating to on-line purchase transactions vs. in-person purchase transactions may also be included.

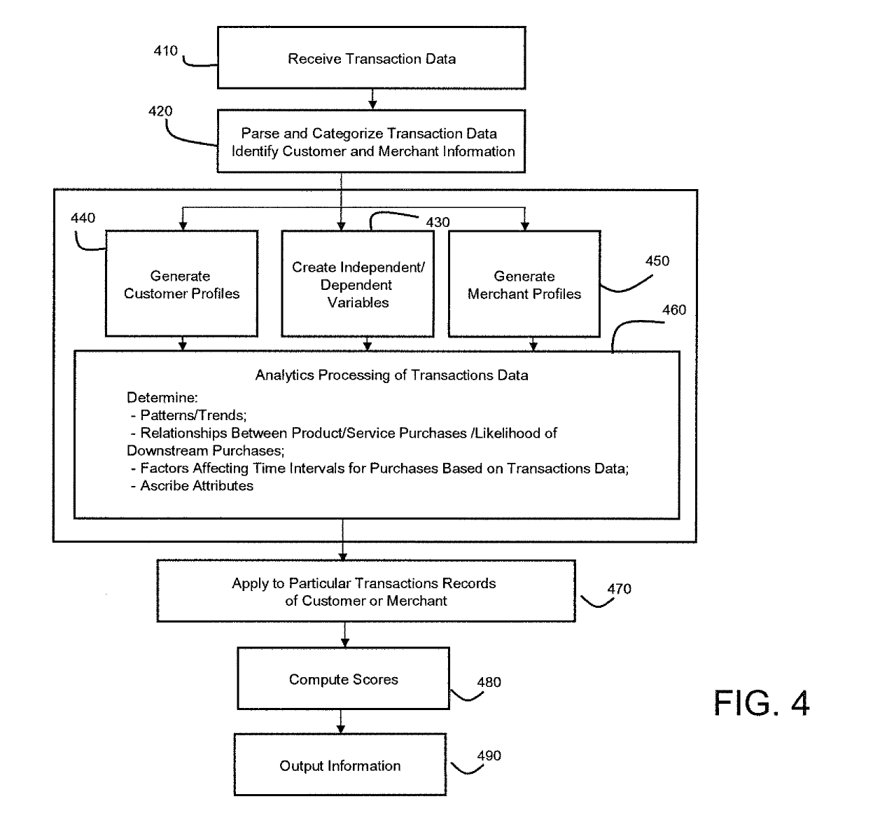

Payment card transaction records may include transaction date 314 as well as customer information 316 and merchant information 318. Customer information 316 may further include customer account identifier (ID) and customer type, as provided in an exemplary transaction record illustrated in FIG. 4. Customer geography and demographics data may be obtained by modeling of the customer information and may be categorized for example, by local, regional, state, country and/or other geographic or population and statistical boundaries. Merchant information 318 may include information as to the sellers in a given transaction and include merchant name, merchant type or line of business (MCC code), geographic location of the merchant or purchase, information relating to the purchase amount and date of purchase, date of delivery or service, type and the like.

The transaction data is categorized or grouped by the processor in a plurality of ways so as to decompose or break down the various informational components of the transaction data collected within the database. Payment card transaction data 310 stored in managing computer system 110 may be filtered 330 according to the requirements of a particular application in order to selectively identify specific merchants and/or industries from a list of merchants or industries for targeted analysis. By way of non-limiting example only, the transactions data may be filtered according to different rules or targeting criteria, such as merchant type (e.g. fuel delivery companies, auto dealers, etc.), for targeted analysis. In another example, filtering of the transactions data may be performed according to a temporal sequencing of transaction events and/or temporal intervals (e.g. last five years' data, seasonal date ranges, product servicing frequency, etc.) as well as by merchant or merchant category. Further filtering (e.g. by geographical location, e.g. region, state, county, city, zip code, street) may be applied to further target particular aspects of the transaction data for given applications.

An analytics engine 350 operates on the transaction data by performing statistical analyses in order to construct logical relationships within and among the transactions records data in order to determine those customers that purchased a particular serviceable property (e.g. cars, boats, gasoline purchases, oil burning water heaters, etc). Various types of models and applications may be configured and utilized by analytics engine 350 in order to derive information from the transactions data. Such statistical analyses and modeling may include independent and dependent variable analysis techniques, such as regression analysis, correlation, analysis of variance and covariance, discriminant analysis and multivariate analysis techniques, by way of non-limiting example. By way of example only, variables may be defined according to different merchant categories and may have different degrees of correlation or association based on the type or category of merchant. Similarly, different products and/or services of particular merchants may likewise have different degrees of correlation or association. Furthermore, variable analysis of purchasing frequency with respect to particular products and/or merchants may also be utilized as part of the analytical engine 350 in order to determine particular consumers who purchase a given serviceable property.

Further analytical processing of the transaction data includes performing one or more of variable analysis purchase sequencing, segmentation, clustering, and parameter modeling to establish profiles, trends and other attributes and relationships that link merchants, customers, events and serviceable properties. For example, the analytics engine operates on the transactions records to cluster or group certain sets of objects (information contained in the data records) whereby objects in the same group (called a cluster) express a degree of similarity or affinity to each other over those in other groups (clusters).

Data segmentation of the transactions data associated with analytics engine 350 includes dividing customer information (e.g. customer IDs) into groups that are similar in specific ways relevant to other variables or parameters such as geographic region, spending preferences, customer type (e.g. individual consumer or business), demographics, and so on.

The transactions data may be further analyzed based on purchase sequencing for a particular customer ID in order to determine patterns and/or purchasing behaviors, trends and frequencies of a particular customer based on the transactions records in the database.

Through these analytics processes, the transactions data is categorized in as many ways as possible and the analytics engine then determines relevant characteristics associated with categorized transactions data according to particular transactions records of interest and/or filtering information based on a particular application.

By way of further non-limiting example, as shown in FIG. 3, statistical and variable analysis processing 370 is utilized in order to ascribe attributes to purchasers of a given serviceable property. Variables such as time, purchase frequency, purchasing geography and location, aggregate customer spending, and the like may be used to develop profiles for particular serviceable properties, merchants, and customers, as well as more generalized aggregate profiles directed to classes or categories of serviceable properties, merchants, customers, and regions, as well as overall within a particular serviceable property category.

The profiles and attributes from block 370 may be applied to one or more particular customers 382, merchants or service providers 384, markets 386, and other applications 388 in order to provide particular insights for a select application. Such applications include by way of non-limiting example, providing enhanced client list data to a particular service provider with predicted service intervals tailored to each particular customer in view of overall customer transaction data. Additional applications may be directed to customer prospecting, customer relationship management, service interval predictions and reminders, as well as comparative profiling and evaluation of merchant and/or market costs of serviceable properties and output to the particular requestor/user based for example, on the specific user request or according to rule based processing.

Each or any combination of the modules and components shown in FIG. 3 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 3, these modules may perform functionality described later herein.

FIG. 4 shows an exemplary process flow wherein transactions records data 312 (FIG. 3a, 3b) for one or more transactions containing customer account identifier (customer ID), customer geographic data, customer type, customer demographics data, merchant identifier (e.g. merchant name), merchant geography, and line of business is received (block 410) and then processed (block 420). As discussed hereinabove, analytics processing is performed on the data to categorize the transactions records data in a multiplicity of ways, in order to determine associations or logical relationships between components of the transactions records and derive drivers that influence frequencies associated with particular actions by purchasers of serviceable properties.

Categorization (block 420) may be performed in order to identify particular merchants or customers associated with a transaction purchase of a given product or service. The transaction data input to the analytics engine serves as either independent or dependent variables for processing. Variable definitions (block 430) may be created within the analytics engine for analysis of select products, merchants, services, actions, and/or customers, by way of non-limiting example. Specific preferences and profiles may also be generated and stored in the analytics engine for application to transactions records associated with particular categories of products, merchants, and/or customers, by way of non-limiting example only. In one exemplary embodiment, a particular type of transaction property (e.g. fuel purchase transactions) may be identified for analysis. The transactions records in the transaction database are processed and determined from the customer profile data (block 440) in order to categorize those merchants falling within that particular category. Profiles (block 450) for each merchant are also generated and may be further segmented according to geographic location, size, relative transaction amounts (which may be indicative of a type of customer or business to business), and the like.

Processing continues (block 460) wherein the categorized transactions data and customer and merchant profiles are processed according to select independent, dependent and/or specialized variables to identify trends, customer behaviors, and relationships between product and service purchases by customers, purchasing frequency intervals relating to particular customers, merchants and/or products and services, and probabilities associated with the likelihood of future customer purchases of particular products based on the analysis of the transactions data. Such variables may be derived from particular transaction data or alternatively, used as default variables and updated as part of the analytic engine. Different weighting values or coefficients may be applied to the different variables in order to more finely tune the analysis. For example, more recent transaction data may be weighted more heavily than older transaction data. Likewise, transactions records reflecting purchases in geographical areas outside of a predetermined area may be weighted less (or more) than those within the area, depending on the application.

Various standard statistical processing techniques including but not limited to regression analysis, correlation, analysis of variances, segmentation and clustering applied to the transactions data in order to determine and predict the effect particular categories of data have on other categories, and thereby determine drivers of particular actions (purchased services) associated with a serviceable property represented in the transactions data.

Based on the analytical transaction data processing, select attributes are ascribed to customers or purchasers of a serviceable property. Such attributes, preferences, tendencies, correlations and associations are then applied (block 470) to select transactions data records for particular customers or merchants for the given serviceable product in order to provide information and insight relative to a select application (e.g. specific customer, merchant, service interval and/or property to be serviced).

For example, application of the analytical engine and determined dominant factors or drivers to particular transactions records of customers or merchants of a select serviceable property (block 470) results in computation of probability scores or likelihood indicators (480) for predicting the likelihood of outcomes such as future purchases (i.e. future transactions), intervals associated with the future transactions, and predicted spending patterns. The results may be applied to a particular set of customer, merchant and/or transactions records data and output (block 490) from system 110 (FIG. 1) to provide informational messages, alerts, and/or data enhancements in the form of customer lists, for example, in order to deliver insights to particular market segments, merchants, customers, and/or service providers.

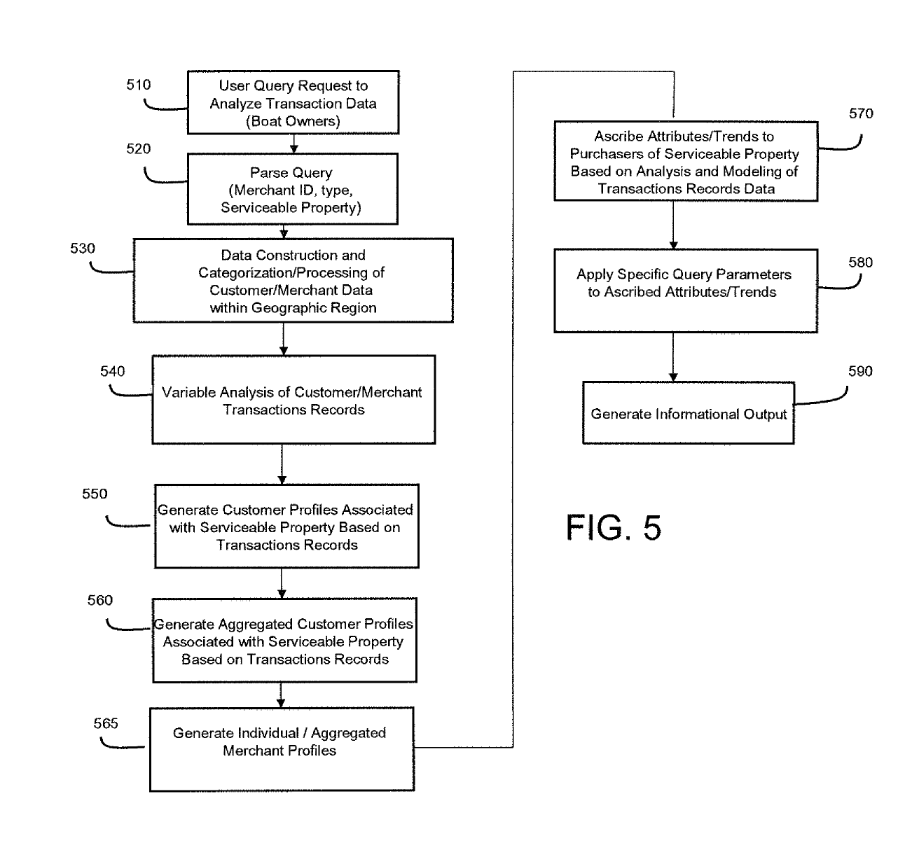

FIG. 5 illustrates an exemplary system and process flow according to an embodiment of the present disclosure for determining relational characteristics and traits associated with a given serviceable property and applying said determined characteristics and traits to generate useful information for output to a third party concerned with events correlating to the serviceable property. By way of example, a merchant (e.g. a local marina owner) associated with a serviceable property (e.g. boats) may submit a query (block 510) requesting customer information (e.g. via computer system 121 of FIG. 3) concerning the serviceable property.

For example, the query may request a list of likely new boat owners within a given local geographic region (e.g. within the state of Virginia). The query is parsed (block 520) by the computer system 110 (FIG. 1) to determine the serviceable property (e.g. boat purchase) and relevant additional delimiters. Based on the query, transactions records stored in the transactions database are processed via the analytics engine (block 530) according to statistical analyses discussed hereinabove for determining those customers that have purchased the serviceable property (boats).

For example, various criteria (independent and dependent variables and parameters/constraints) may be utilized in order to obtain a listing of boat owners based on processing of the payment card transaction data. Such processing may be based on analysis of customer and merchant payment card transaction records data (block 540) such as customer id, type of merchant (boat seller), date/time of purchase, amount (e.g. purchases falling within min/max values associated with typical boat purchases), geographic region of seller (e.g. seller location/zip code), geographic region of customer (e.g. customer address/zip code), associations of customer with the particular geographic region of the requestor (e.g. whether a potential/determined boat owner vacations or conducts business transactions within the geographic area of the local marina owner, the type and frequency of such transactions); and purchase sequencing of customer transactions within a given time interval of one or more particular purchases to assess characteristics and attributes of potential customers. For example, transactions records indicating a large ticket purchase at a boat dealer merchant, followed within a given time interval by purchases at a boat pump-out station merchant, indicates a likelihood of a customer's new boat purchase at a merchant boat dealer.

Furthermore, usage of the serviceable property may be determined based on analysis of various types of payment card transactions relating to the serviceable product, such as transaction record ticket price, dates, relative frequencies, and locations associated with fuel purchases, by way of non-limiting example. Information relating to the degree of use, geographic location and seasonal boundaries, by way of example only, may be derived from analysis of such transaction records data.

The analysis may encompass a multi-stage processing approach whereby in the initial stage all determined purchasers of the serviceable property (i.e. all boat purchasers within a given geographic region) are identified according to the analytical engine processing, and customer profiles (block 550) for each identified boat owner are determined based on filtering the transactions records and purchasing history of each respective customer. In addition, the transactions records of customers (or purchases) may be correlated according to the degree of similarity of one or more features associated with purchase types, purchase frequencies, related purchases and frequencies and dates of such purchases, purchase amounts, aggregated spending, and the like, in order to determine aggregated customer profiles (vice individual customer profiles), indicative of a particular type of customer and purchasing pattern or behavior directed to a group of customers (block 560). Likewise, individual and aggregated merchant profiles may be generated based on analysis of the merchant spending profiles, characteristics, amounts, types and frequencies of purchases (block 565) according to the transactions data using segmentation, clustering purchase sequencing and regression analysis. These profiles are used to determine relationships and links between various components for predicting trends, behaviors, and indicators of future actions or events.

Based on the analytical processing, attributes are ascribed to boat purchasers according to their individual and/or aggregated customer profiles (block 570). Geographical filtering may also be applied to determine probabilities, likelihoods, trends, and preferences for purchasers of the particular serviceable property selected. For example, the results of the analytics processing on the transactions data for boat owners associated with a particular geographic region (e.g. Virginia) may yield a strong correlation that purchasers of boats in Virginia tend to store their boats in the month of October. Such probability determination by the system may be expressed in human readable or textual form. That is, these conclusions expressed in human readable or textual form are based on analysis of seasonal fuel purchases associated with boat owners in Virginia and determination of dependencies and drivers of events associated with the serviceable property. Results of the analytics processing may further yield a determination that boat owners in Virginia reserve slips between the months of May through October. This conclusion may be based on analysis of customer and merchant category transactions and timing associated with the data base transactions records (e.g. boat owner transactions with marina owners, frequency of said transactions, average ticket price, correlation of ticket price with boat type and/or purchase amount among customers). These ascribed attributes may be stored in memory and applied to downstream processing of transaction data records.

That is, the particular user request may be applied (block 580) to the analytics engine and attributes ascribed in block 570 in order to output enhanced information (block 590) relating to a service interval for a given action or event of the serviceable property adjusted by the selected data characteristics of the particular request. By way of example, the processing of block 580 is applied to identify a list of likely new boat owners (e.g. boat purchasers within the last 12 months) in a given geographic region (e.g. Virginia, based on boat purchasers with customer addresses, residence, or boat seller's location in Virginia), along with enhanced information identifying the trend that Virginia boat owners store their boats in the month of October and reserve slips between the months of May through October. This information provides a merchant (local marina owner) who is not directly connected with the transactions pertaining to the purchase of the serviceable property (boats) but whose business relates to or depends upon those types of transactions (i.e. boat sales), to gain insight into such purchasers and determine optimized intervals for approaching those potential customers for his/her particular service (i.e. boat slips).

By way of further example, the list of customers may be further processed by comparing the individual customer profile transaction data associated with each customer, with aggregated customer profile transaction data in order to determine differences in one or more of product or service purchases, frequencies of particular types of transaction record purchases, aggregated expenditures, and the like.

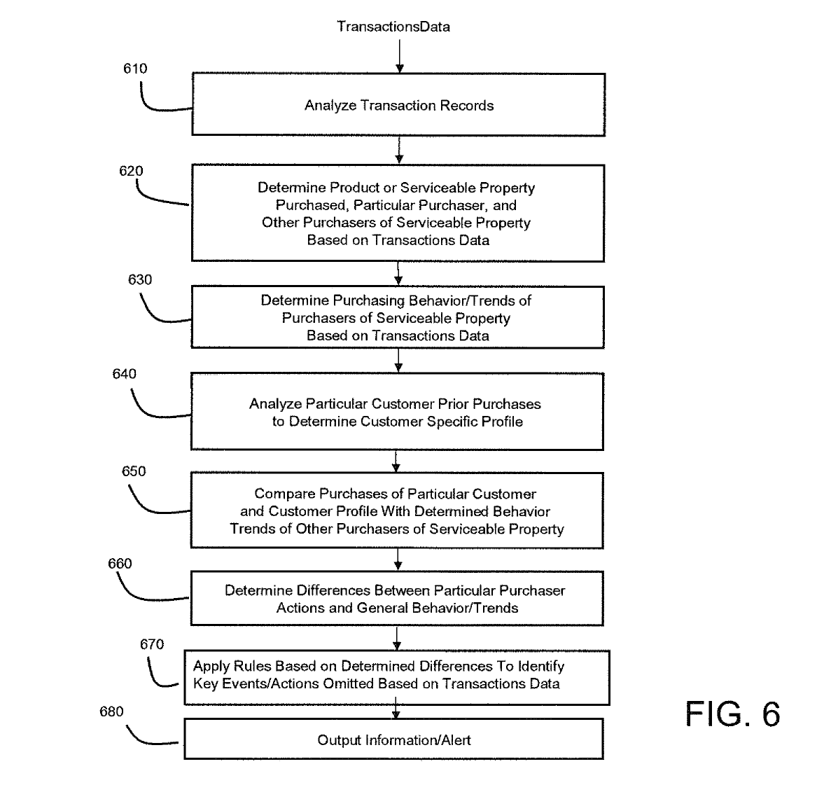

FIG. 6 illustrates an exemplary process flow whereby the system embodied in the present invention performs a transaction analysis 610 of a select payment card transaction to determine 620 the product or serviceable property purchased (e.g. by a particular customer), as well as determine other purchasers of that type of serviceable property. Based on analytics processing of the transactions data records as discussed herein, the system determines 630 general trends, tendencies or probabilities of multiple customers purchasing the particular type of serviceable property. Analysis of the purchasing history and transactions associated with the particular customer purchasing the property identified in block 620 is also performed 640 in order to determine a particular customer profile. Comparison 650 of prior purchases of the select or particular customer (e.g. particular customer profile) with the general purchasing trends and attributes of multiple customers of the particular type of serviceable property determined in block 630 (e.g. aggregated customer profiles) is performed in order to identify differences (block 660) therebetween. In this manner, application of a set of rules (block 670) based on the determined differences between the customer specific profiles and the aggregated profiles for specific events or actions associated with a serviceable property enables direct and immediate identification, communication, and targeting (block 680) of specific actions relevant to the particular serviceable property.

For example, comparison (block 650) of the transaction records of the individual customer profile (block 640) of a new boat owner with the aggregated customer profiles (block 630) of boat owners (multiple aggregated profiles) may yield information (block 660) that certain purchases typically associated with boat owners have not yet occurred for that individual customer, such as lack of purchase of a boat slip by the boat owner. A rule (block 670) or series of rules as is understood in knowledge based systems, may be applied to the determined differences (block 660) in order to identify and/or output to a third party information on key distinct events or actions associated with the serviceable property that have not yet occurred for the particular customer based on analysis of the transactions data. Such enhanced information may be important to the requestor (i.e. local marina owner) to enable the requestor to immediately target (block 680) that list of prospective customers that have not yet purchased boat slips, independent of the seasonal time interval attributes ascribed.

According to another exemplary embodiment, payment card transaction data is analyzed to determine relevant information concerning a serviceable property (e.g. servicing a car) in a particular region. For example, customer profile data may be generated by the computer system based on aggregate customer event and spending data according to payment card transaction records. A predictive model may be established based on an aggregated spending profile which predicts the general frequency of a periodic service (e.g. car service) for a given customer (e.g. customer id) within a given geographic region (e.g. Virginia) using the statistical analysis techniques discussed hereinabove with respect to FIGS. 3 and 4. Predictive models for scoring and rank ordering are known to those of skill in the art and will not be described further for sake of brevity.

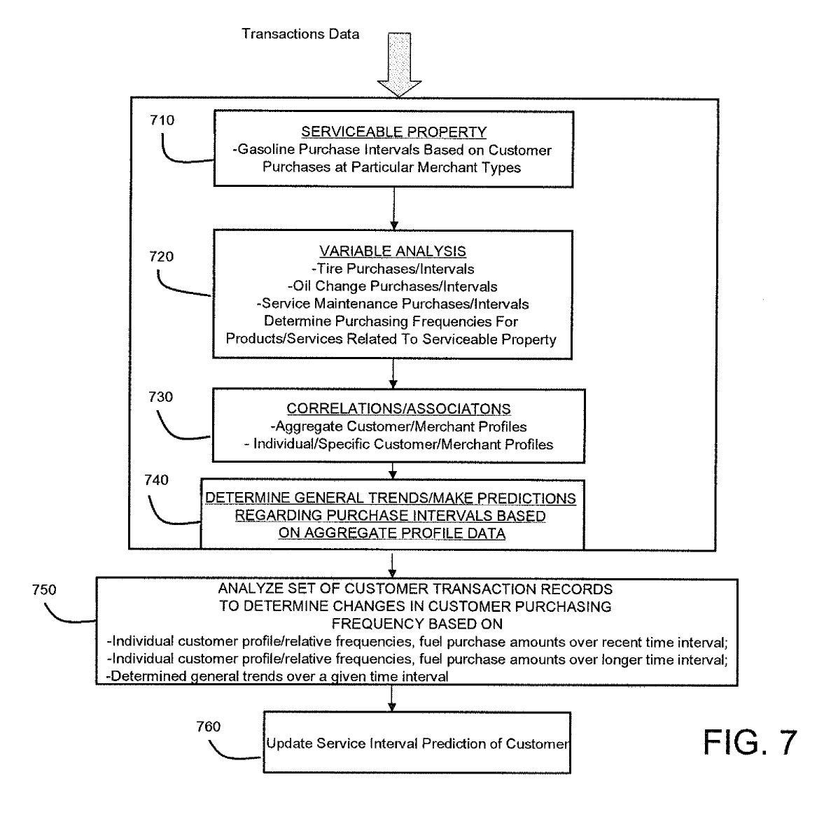

In an exemplary embodiment depicted schematically in FIG. 7, profile attributes ascribed to purchasers of a serviceable property (block 710) based on payment card transactions data may depict a strong direct correlation between the frequency and amount of fuel purchased by a customer (e.g. car owner) and the time interval between events such as car services (e.g. oil changes, new tire purchases, and service interval maintenance such as 30,0000 mile checkups). For example, aggregate customer data analysis (block 720) is performed utilizing one or more independent/dependent variables attributed to the frequency intervals of car services based on the transactions data may be analyzed by the system (using for example, regression analysis) to determine (block 730) a degree of correlation (e.g. strong, moderate, weak correlation) between the frequencies with which transaction purchases of fuel are made and the frequencies with which car service transactions occur. Such attributes ascribed to customers may of course further vary according to additional factors or variables such as purchase amounts, geographic location, type of vehicle, age of vehicle, and the like. Further, the system may be configured to determine, based on analysis of aggregate customer purchasing payment card transactions (e.g. purchase transaction records of multiple customers), that the general trend (block 740) may be for a car to be serviced (e.g. oil change) every 6 months, based on a given frequency interval (i.e. a determined or nominal window or range number of gas purchase transactions) associated with gas purchases and transaction amounts.

Based on analysis of: 1) the individual customer profile associated with the relative frequencies and amounts of fuel purchases over a given time interval (e.g. last 3 months worth of transactions data), 2) comparison with the individual customer's profile of relative frequencies and amounts of fuel purchases over a prior given time interval preceding the first interval and greater than said first interval (e.g. prior 12 months worth of transactions data), and 3) comparison of the general trend for frequency of oil changes based on gas purchasing frequency over a given time interval, the system is configured to analyze changes to the variables determined to be drivers of service interval frequency and thereby determine, deduce, or infer changes (block 750) in customer behavior (e.g. increased amount of driving) related to the serviceable property (e.g. fuel purchases). Relational data events and variable factors (e.g. recent increases in the frequency of gasoline purchases) may be further applied to a particular customer's profile in order to adjust the service interval prediction (block 760) of the particular customer. By way of example only, a specific customer's historical car service transactions records may be analyzed in combination with additional payment card transaction data indicating that the particular customer is purchasing gasoline over shorter intervals (without commensurate decrease in ticket cost). The system is configured to detect this relationship based on processing of the transactions data records associating a given customer's purchases and amounts with a particular category of merchant (MCC code or merchant IDs) over a given interval, and provide an updated service interval prediction for the customer based on the additional factor(s). As discussed herein with regard to FIG. 6, such determination may be applied to a rules engine to alert a third party (e.g. a merchant such as a mechanic or car dealership, or the customer) that the particular customer may require more frequent servicing than in the past.

In a further non-limiting example, the system may be configured to perform payment card transaction analysis on customer records associated with a serviceable property such as a septic tank. The transaction records for a given customer are analyzed to identify periodic features (e.g. tank maintenance/servicing) associated with a base event (e.g. purchase of a septic tank) and to predict future occurrences associated with one or more serviceable features correlated to that event (e.g. tank servicing/drainage).

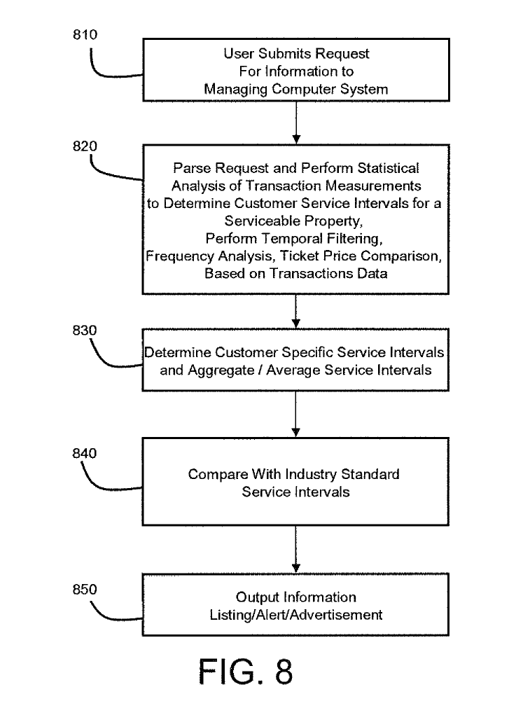

In one embodiment illustrated in FIG. 8, the system operates responsive to a merchant's request 810 (e.g. septic tank service provider) for determining relative time periods for which merchant tanks have been serviced (e.g. emptied). The system parses the request 820 and provides as an output 850 to the requesting merchant a listing of septic tank customers and their relative historical time frames for being emptied based on statistical analysis and profiling of the payment card transactions data and aggregate customer and/or merchant spending profiles. The system may also derive the relative frequency interval for a specific customer based on the transactions records, as well as an aggregated profile of all customers and their average service intervals, in addition to information correlated to average seasonal service. In one embodiment, the determined average may be calculated as the arithmetic average (mean). In other embodiments, the average may be calculated as the median, mode, geometric mean and/or

For example, based on the payment card transaction data, the computer system may determine (block 820) from the transactions data (e.g. by counting the frequency of transactions associated with a given customer and merchant category or ID (e.g. sewage service) and comparing the ticket price over a given time interval) that a particular customer empties his or her septic tank on an annual basis. The relative timing (calendar dates) associated with these servicing transactions may also be determined and analyzed (e.g. service activities occur in the December time frame). Customer specific service intervals as well as aggregate/average customer service intervals are calculated (block 830) based on the transactions data. In response to this determination, the computer system may also prompt (block 850) the merchant to send to a particular customer a targeted advertisement or reminder at a given time interval prior to the anticipated December servicing time frame (for example, October) to optimize the likelihood of service for that property. In addition, the system may compare (block 840) the particular customer profile with an aggregated customer profile of similar customers, or to a normalized/industry recommended standard, in order to assess whether the servicing intervals associated with the particular serviceable property are within the nominal/normal range of the recommended standard or fall outside of the determined acceptable range.

For example, if a particular customer's service profile indicates a yearly (annual) servicing activity, while aggregated customer profiles and/or industry recommended standards indicate a recommended 6 month servicing interval, the system may be configured to compare these values and generate and output an alert message advising as to the customer's historical records and of the need to increase service activities based on aggregated customer profiling. Further still, timing information associated with the particular servicing intervals may be derived from the transaction data and utilized with respect to the customer specific profile as well as an aggregated profile to assess the preferred time(s) of year for which servicing is recommended, and compare with the actual customer data to provide customer information and recommendations as to the appropriate servicing interval and seasonal time period (e.g. December and May).

In other exemplary embodiments, the system of the present disclosure performs payment card transaction analysis responsive to user (e.g. customer or merchant) requests to summarize and determine events and time intervals related to serviceable properties. Such processing includes outputting service reminders for a given serviceable property, for example, notification of a last time interval (e.g. 12 months) since a given customer's septic tank was drained). In addition, the system of the present disclosure may be responsive to various types of inputs for initiating the transaction analysis, determination, and informational output based on payment card transactions data and/or rules triggered in response to processing of such data.

As described above with respect to FIG. 8, the system 110 of FIG. 1 may be configured to accept and process a user request for information (via user terminal 121) relating to a serviceable property based on the stored payment card transactions data.

By way of further example, a query may be submitted via a user terminal to request an estimate of ongoing payment costs within a given time interval (e.g. 5 years) associated with a serviceable event such as the purchase of a boat. Parameters related to the particular type or category of boat (e.g. commercial, leisure, motor, sailboat, etc.), estimated purchase price (e.g. $15,000), estimated usage (e.g. seasonal, number of months used per year), geographic region (e.g. California), and/or additional parameters may be included in the user query for input to the system 110. The system is configured to determine and categorize the relevant transaction data by filtering the data according to one or more of the above-identified parameters in order to extract from the transactions data the spending profiles associated with customers who have purchased a similar type of boat. Various algorithms and filters may be implemented in order to tailor the particular set of transactions data for analysis. For example, filtering of the transactions data may be performed according to purchase price (e.g. boat purchases ranging from $10,000 to $25,000) in order to eliminate relative large (luxury boat) purchases as well as smaller (economy boat) purchasers from the analysis. Additional filtering and/or weighting of customer profiles matching the given price range may be performed based on additional parameters. Compilations of customer transactions that correspond to boat-related purchases (e.g. storage costs, fuel transactions, part purchases, repair transactions) including frequency intervals, and transaction amounts (ticket price) are made and categorized by customer. Customer profiles that sufficiently match the particular query parameters are used in order to obtain the estimate. The customer cost profiles may be aggregated and normalized/averaged in order to obtain an estimated cost associated with a prospective boat purchase. Processing may include determining average frequencies and costs over a given interval (e.g. first 5 years) associated with such parameters as fuel purchases, storage and maintenance, and part purchases in order to smooth data due to outliers. The aggregated spending associated with each of the relevant customer profiles may be calculated and different weights applied to different profiles depending on the relative degree of similarity to the user input parameters, in order to obtain a more precise estimate of the total costs based on the payment card transactions data.

By way of further example, the system may be queried to obtain information relating to the average aggregate number and cost of customer car services for those customers who service their cars within a relatively short interval (e.g. four times per year) relative to aggregate or overall number and cost of customer car services whose intervals are longer (e.g. an interval of twice per year). Profile data is generated from the transactions data relating the particular service category and costs per service. Customer profiles that sufficiently match the particular customer query and region/location and other qualifying features may provide insight into optimizing a vehicle's service interval by making more frequent service appointments based on the overall cost savings in the long term.

Still further, merchant specific information may be obtained by querying the system to determine, based on the transactions records, relevant service related costs for specific merchants and comparison of the merchant profile data. For example, a user may query the system in order to compare particular auto mechanics. Transactions records data for a given merchant (auto mechanic) may be categorized and calculated per customer, amount, and frequency interval in order to obtain merchant profile data useful for providing insight into the particular merchant's business. Furthermore, the system may be configured to output a comparison of merchants based on their profiles. In one non-limiting example, determination of merchant profile data identifies that customers of a given merchant (e.g. mechanic A) on average make four (4) transactions per year at an average of $100/visit ($400 total annually), whereas customers of a competing merchant (e.g. mechanic B) average 2 transactions per year at an average of $250/visit ($500 total annually). Such information may be useful to both consumers as well as other merchants in selecting business relationships.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

1. A system for determining service intervals of a serviceable property based on payment card transaction data, the system comprising:
one or more data storage devices containing payment card transaction data of a plurality customers and merchants;
one or more processors;
a memory in communication with the one or more processors and storing program instructions, to cause the one or more processors to:
identify purchasers of serviceable property based on processing payment card transaction data of a plurality customers and merchants in said one or more storage devices, the processing including statistical analysis of said payment card transaction data to identify relationships between different payment card transactions representing a correlation of a given property of a purchaser with a particular service linked to said property;
determine, based on said payment card transaction data of the plurality of customers and merchants characteristic traits of purchasers of said serviceable property for purchasing services linked to said serviceable property, and relating to the frequency of service intervals for a given service linked with said serviceable property, to thereby provide profile data;
determine a particular serviceable property identifiable from said payment card transaction data, and apply to it the determined profile data, along with one or more selected data characteristics associated with a given service linked to said serviceable property, to thereby obtain data representative of an updated service interval for a given service associated with the serviceable property.

2. The system of claim 1, wherein the one or more processors is operative to output an indication of a recommended change to the service interval for the given service associated with the serviceable property.

3. The system of claim 2, wherein the profile data includes one or more customer profiles, merchant profiles, and transaction profiles.

4. The system of claim 1, wherein the recommended change to the determined service interval is based on comparison by said one or more processors of service intervals of a given service of a particular customer with at least one aggregated list of customers matching the profile of said particular customer.

5. The system of claim 1, wherein the recommended change to the determined service interval is based on comparison by said one or more processors of service intervals of a given service of a particular customer with an industry standard value.

6. The system of claim 1, wherein the statistical analysis of said payment card transaction data comprises at least one of i) a trend analysis, (ii) a time series analysis, (iii) a regression analysis, (iv) a frequency distribution analysis, (v) and predictive modeling.

7. The system of claim 1, wherein the one or more processors is further configured to determine one or more purchasing differences between particular customer purchases of one or more services linked with said serviceable property, and an aggregate customer trend profile of purchases of said one or more services, to which said particular customer belongs, and to output an alert based on said determination.

8. The system of claim 7, wherein said alert is output according to one or more rules and indicative of a detected omission in purchasing by said particular customer of a service associated with said serviceable property.

9. The system of claim 8, wherein the statistical analysis processing of said payment card transaction data for determining characteristic traits of purchasers of said serviceable property for purchasing services linked to said serviceable property is limited to payment card transactions occurring within a limited geographic region.

10. A computer-implemented method for determining service intervals of a serviceable property based on payment card transaction data, the method comprising:
identifying, by a processor, purchasers of a serviceable property based on processing payment card transaction data of a plurality customers and merchants in said one or more storage devices, the processing including statistical analysis of said payment card transaction data to identify relationships between different payment card transactions representing a correlation of a given property of a purchaser with a particular service linked to said property;
determining, by a processor, based on said payment card transaction data of the plurality of customers and merchants characteristic traits of purchasers of said serviceable property for purchasing services linked to said serviceable property, and relating to the frequency of service intervals for a given service linked with said serviceable property, to thereby provide profile data;
determining a particular serviceable property identifiable from said payment card transaction data, and applying to it the determined profile data, along with one or more selected data characteristics associated with a given service linked to said serviceable property, to thereby output data representative of an updated service interval for a given service associated with the serviceable property.

11. The method of claim 10, further comprising outputting an indication of a recommended change to the service interval for the given service associated with the serviceable property.

12. The method of claim 11, wherein the profile data includes one or more customer profiles, merchant profiles, and transaction profiles.

13. The method of claim 10, wherein the recommended change to the determined service interval is based on comparing service intervals of a given service of a particular customer with at least one aggregated list of customers matching the profile of said particular customer.

14. The method of claim 10, wherein the recommended change to the determined service interval is based on comparing service intervals of a given service of a particular customer with an industry standard value.

15. The method of claim 10, wherein performing statistical analysis of said payment card transaction data comprises performing at least one of i) a trend analysis, (ii) a time series analysis, (iii) a regression analysis, (iv) a frequency distribution analysis, (v) and predictive modeling.

16. The method of claim 10, further comprising determining one or more purchasing differences between particular customer purchases of one or more services linked with said serviceable property, and an aggregate customer trend profile of purchases of said one or more services, to which said particular customer belongs, and outputting an alert based on said determination.

17. The method of claim 16, wherein said alert is output according to one or more rules and indicative of a detected omission in purchasing by said particular customer of a service associated with said serviceable property.

18. A computer-implemented method for determining characteristic information relating to a serviceable property based on payment card transaction data of customers and merchants, the method comprising:
processing payment card transaction records via an analytics engine utilizing statistical analyses and techniques to determine one or more relationships, patterns, and trends among transaction records to determine factors for predicting future transactions and estimated times and frequencies associated with such future transactions based on customer and merchant transaction profiles associated with a given serviceable property;
applying those determined factors to particular sets of payment card transaction data associated with a particular subset of customers and processing said particular sets of payment card transaction data using said analytics engine to predict in real time when said particular subset of customers of a serviceable property requires service.

19. The method of claim 18, further comprising said analytics engine using one or more independent and dependent variables representative of one or more purchasing events, customer profiles, merchant profiles, purchase amounts, and purchasing frequencies, for determining said factors.

20. The method of claim 19, further comprising linking to the serviceable property characteristic traits or profiles of the customers that relate to specific actions based on past purchase transactions, and analyzing the frequency relationship for a given action associated with the serviceable property to determine factors and conditions satisfying a given threshold level deemed to influence or predict a frequency relationship of the particular service associated with the serviceable property.
